(19) United States
(12) Patent Application Publication
(10) Pub. No.: US 2013/0142581 A1
(43) Pub. Date: Jun. 6, 2013

(54) HIGH FEED CUTTING INSERT

(71) Applicant: Vladimir Volohk, Maalot (IL)

(72) Inventor: Vladimir Volokh, Maalot (IL)

(73) Assignee: KENNAMETAL INC., Latrobe, PA (US)

(21) Appl. No.: 13/370,489

(22) Filed: Feb. 10, 2012

(30) Foreign Application Priority Data
Feb. 27, 2011 (IL) 211444

(51) Int. Cl. B23C 5/20

(52) U.S. Cl. CPC B23C 5/207
USPC 407/114

(57) ABSTRACT

A replaceable insert for tipped cutting tools is described. The replaceable insert has a peripheral wall bounding a first surface and an opposite second surface in which at least one of the first and second surfaces is convex.

### FIELD OF THE INVENTION

The present invention relates to a replaceable insert for high-feed cutting tools, more particularly to a replaceable insert with at least one convex face.

### BACKGROUND OF THE INVENTION

Modern high-performance cutting tools use replaceable and typically indexable inserts owing to the high cutting speeds and feeds supported by the superior insert materials. Common materials for inserts include tungsten carbide, polycrystalline diamond and cubic boron nitride.

Indexable inserts use a symmetrical polygonal shape, such that when the first cutting edge is blunt they can be rotated or flipped over, presenting a fresh cutting edge which is accurately located at the same geometrical position. Geometrical repeatability saves time in manufacturing by allowing periodical cutting edge renewal without the need for tool grinding, setup changes, or entering of new values into a CNC program.

Common shapes of indexable inserts include square, triangular and rhombus (diamond) providing four, three and two cutting edges respectively. An invertible square insert for instance, that is made to be flipped over, is provided with eight cutting edges.

High-feed milling is a known technique that pairs shallow depth of cut with high feed per tooth, giving higher metal removal rate than normal. Chip thinning is achieved by utilizing a small lead angle when measured between the cutting plane and the cutting edge (α in FIGS. 10a and 10b) and a long cutting edge (L in FIGS. 10a and 10b) while high-feed rates compensate for the shallow depth of cut to maximize productivity. A significant advantage of the high-feed milling technique is related to the fact that the cutting forces are directed at the machine spindle in the axial direction, reducing vibrations, improving surface quality and extending tool life.

However, a disadvantage of the high-feed milling technique relates to the fact that the insert must withstand the elevated axial forces exerted along the lengthy cutting edge. As a result, cutting inserts used in high-feed milling cutters tend to break across the clamping hole wherein the insert cross-section is minimal.

Even those flat inserts which are secured with a clamp against a central cavity tend to break along the clamping line.

The above problem is described in more detail in U.S. Pat. No. 6,379,087 by William M. Alexander, to the present applicant, stating: “Whenever a central hole exists within an insert, the overall strength of the insert is somewhat reduced. The strength of the insert is reduced to a lesser degree whenever a cavity is placed within the insert for engagement by a top clamp. Nevertheless, whenever any material is taken from the insert body the insert, to some degree, weakens. The insert must, however, be secured within a toolholder and this typically requires the introduction of either a hole or a cavity within the insert to engage a pin through the insert or a clamp against the insert.”

A remedy suggested by Alexander is to provide a central hole or cavity within an insert having a shape that permits the insert to be clamped in a variety of different index positions while minimizing the amount of material removed from the insert.

However, while the remedy suggested in U.S. Pat. No. 6,379,087 reduces the problem, it does not provide a complete solution.

Consequently a new approach is required in order to improve the toughness and extend the life of indexable inserts that are used in high-feed tipped tools in general and milling cutters specifically.

### SUMMARY OF THE INVENTION

Accordingly, it is an object of the present invention to provide an improved cutting insert for high-feed tipped tools that is strong enough to withstand the elevated axial forces developed in the high-feed cutting process.

This object is achieved according to one aspect of the present invention by providing a replaceable insert for tipped cutting tools, said replaceable insert comprising a peripheral wall bounding a first surface and an opposite second surface at least one of which surfaces is convex. A curved cutting edge is formed circumferentially by the intersection of the entire peripheral wall and at least the first convex surface.

Optionally, the second surface is also convex and a curved cutting edge is formed circumferentially by the intersection of the entire peripheral wall and each of the first and second convex surfaces.

Typically, a circumferential tunnel surrounds at least the first convex surface along the cutting edge, providing a positive cutting angle and chip-breakage properties.

Preferably the peripheral wall is defining a polygonal shape. The polygonal shape being of a rotational symmetry and the insert is indexable about the rotational symmetry center line.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1a is a front view of a high-feed triangular insert according to an embodiment of the present invention;

FIG. 1b is a cross-sectional view taken along line A-A in FIG. 1a;

FIG. 2a is a front view of a high-feed square insert according to an embodiment of the present invention;

FIG. 2b is a cross-sectional view taken along line B-B in FIG. 2a;

FIG. 3 is a perspective view of the triangular insert of FIG. 1a;

FIG. 4 is a perspective view of the square insert of FIG. 2a;

FIG. 5 is a perspective view of a dual blade cutting tool making use of square inserts made in accordance with the present invention, secured by a lever clamp;

FIG. 6 is an exploded perspective view of a dual blade cutting tool making use of triangular inserts made in accordance with the present invention, secured with a lever clamp;

FIG. 7 is a perspective view of a dual blade cutting tool making use of a through-hole triangular inserts secured by a screw;

FIG. 8 is an exploded perspective view of a dual blade cutting tool making use of triangular inserts with a round conical cavity for positioning, secured by a lever clamp;

FIGS. 9a and 9b are exploded perspective views of a dual blade cutting tool using inserts with an indexing cavity for positioning, secured by a lever clamp; and

FIGS. 10a and 10b are schematic front views of the cutting tools, of FIGS. 5 and 6 respectively, demonstrating the lead angle and cutting edge length.

### DETAILED DESCRIPTION OF THE INVENTION

In the following description, identical elements that appear in more than one figure or that share similar functionality will be indicated by identical reference numerals.

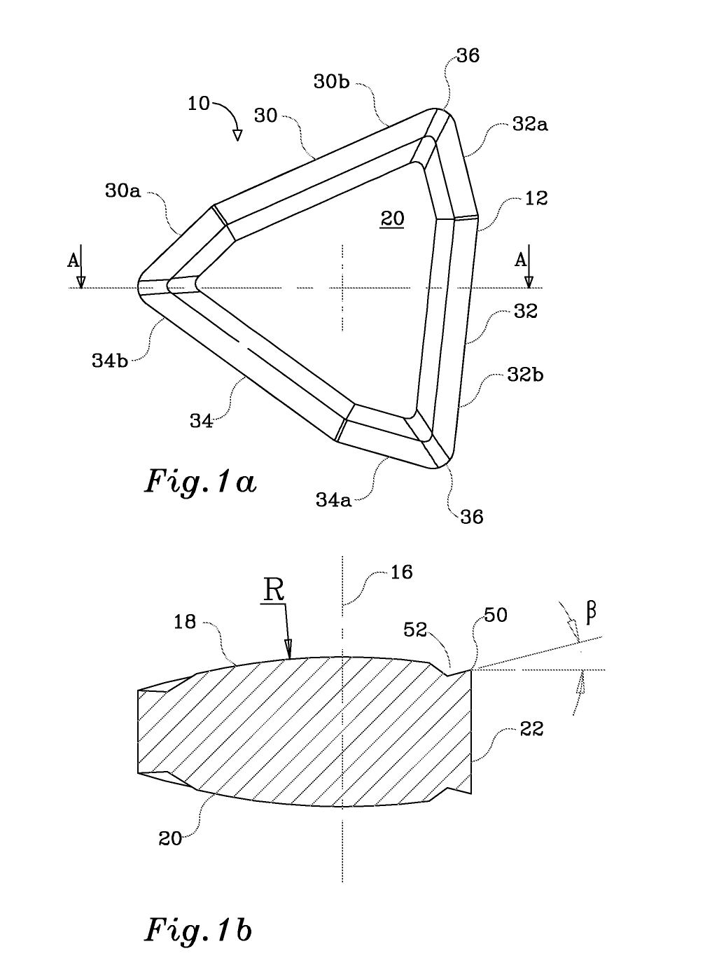

With reference to FIGS. 1a to 4, there are shown a triangular and a square indexable insert generally referenced 10, made according to an embodiment of the present invention for tipped cutting tools such as high-feed milling cutters or turning tools. The insert 10 may accept any polygonal shape with rotational symmetry and is shown here triangular 12 or square 14 by way of an example only. The rotational symmetry axis 16 defines the center line about which the insert 10 may be indexable. The insert 10 has a first convex surface 18, an opposite second convex surface 20 and a peripheral wall 22 therebetween defining the insert polygonal shape. Non-invertible and non-indexable inserts with a single convex surface and an opposite flat surface are also possible and fall within the scope of the present invention.

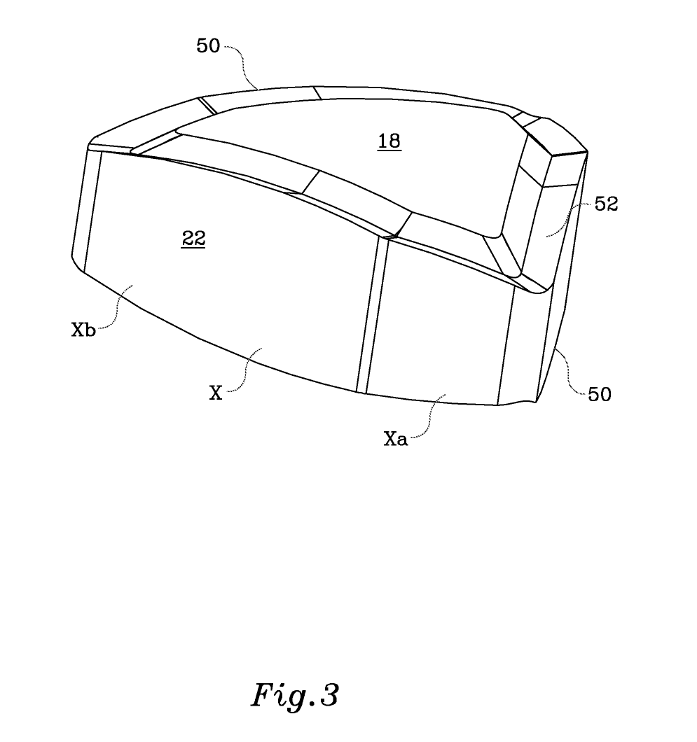

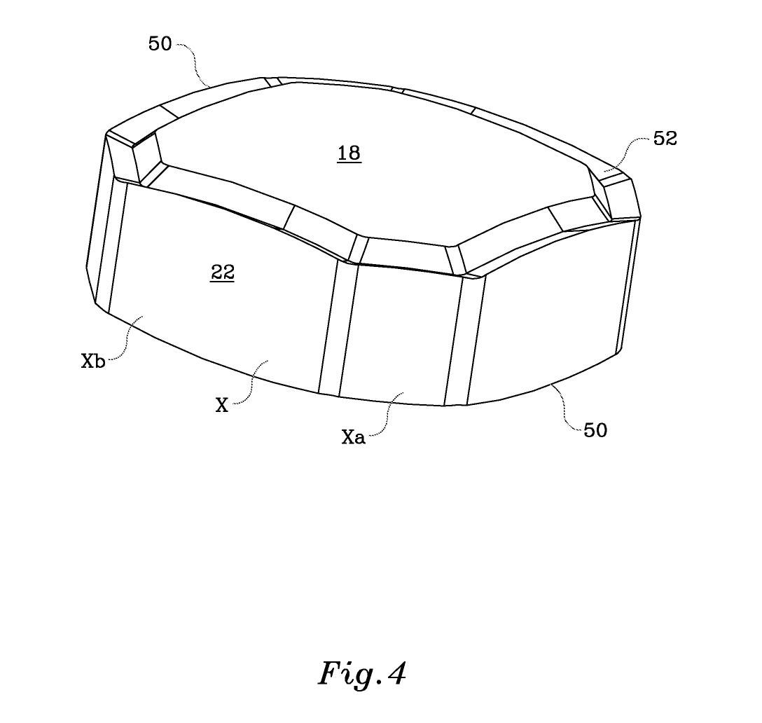

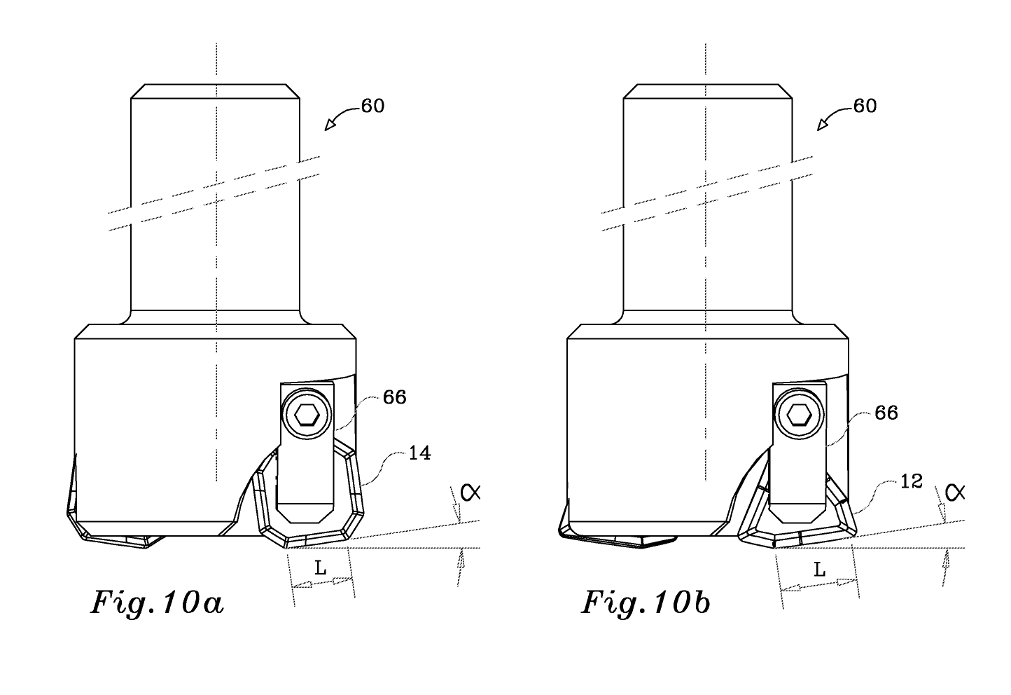

High-feed cutter inserts typically divide each main polygonal side wall X into two sub-faces Xa, Xb (FIGS. 3 and 4) with an angular shift therebetween to provide an appropriate lead angle α as shown in FIGS. 10a and 10b.

Accordingly a triangular insert 12 for example, may have three defining side walls 30, 32, 34 each comprising two sub-faces 30a, 30b; 32a, 32b; and 34a, 34b. In the same manner, a square insert 14 may have four defining side walls 40, 42, 44, 46 each comprising two sub-faces 40a, 40b; 42a, 42b; 44a, 44b and 46a, 46b. Each pair of sub-faces Xa and Xb may be identical in length and angular position as desired for invertible inserts, or may be different in length as is common with non-invertible inserts. The corner regions formed between any two adjacent side walls or sub-faces are preferably curved in the shape of a circular arc 36. A cutting edge 50 is formed circumferentially by the intersection of the entire peripheral wall 22 and at least one of the first and second convex surfaces 18 and 20.

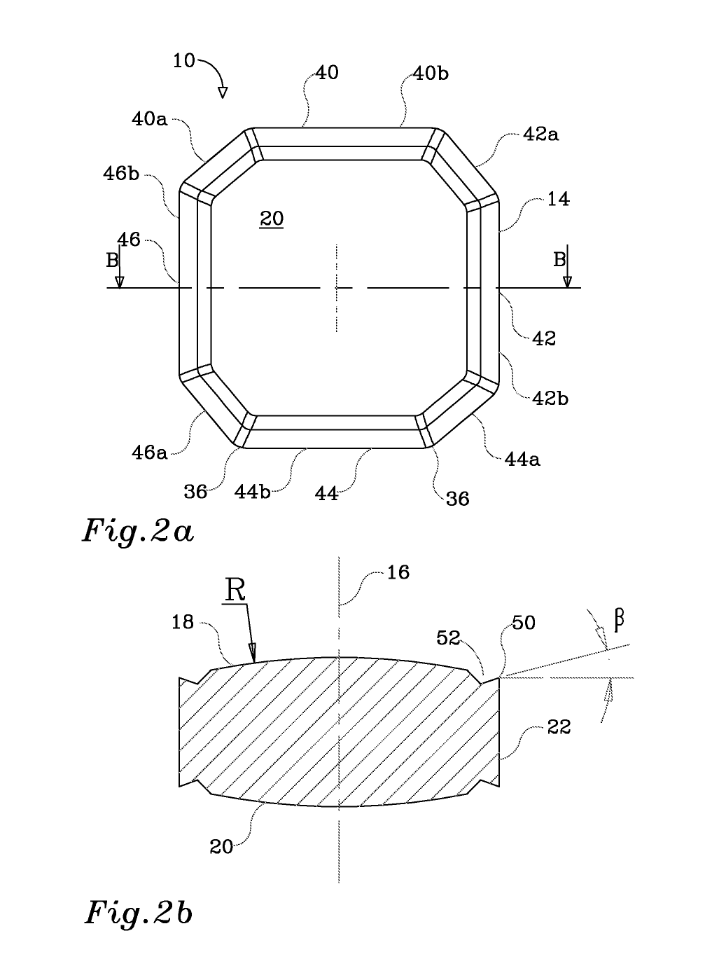

A circumferential tunnel 52 surrounds at least one of the first and second convex surfaces 18 and 20 along the cutting edge 50. The tunnel 52 provides a positive cutting angle β (FIGS. 1b, 2b) and chip-breakage properties for proper operation of the insert 10. It will be noted that the cutting edge 50 does not lie on a planar face, its curvature being defined by the intersection of each of the first and second convex surfaces 18 and 20 and the polygonal peripheral wall 22. The curvature of the cutting edge 50 provides better chip-breakage properties and further thins the depth of cut, both of which contribute in extending the life of the tool.

Directing attention now to the sectional views of FIGS. 1b and 2b, it is seen that owing to the convexity of the first and second convex surfaces 18 and 20, the insert 10 becomes thicker near the rotation symmetry axis 16 at any cross-section passing through the rotation symmetry axis 16, which is also the cross-section of maximum stress in the insert material during operation. Consequently, the stresses are more evenly distributed over the insert volume and the risk of crack or breakage is greatly reduced. It will be understood that even in the presence of a through clamping hole or a clamping cavity as known in the art, the convex-faced insert 10 made according to the present invention is much stronger than a standard flat-faced insert which uses the same clamping technique. Additionally, even a single-sided convex surface insert will have better strength properties than standard flat inserts.

The convex surfaces 18 and 20 are shown spherical in the drawings having a radius R, but to the same extent, they may accept any other convex shape with rotational symmetry such as for example: a cone, pyramid, frustum, or ellipsoid shape.

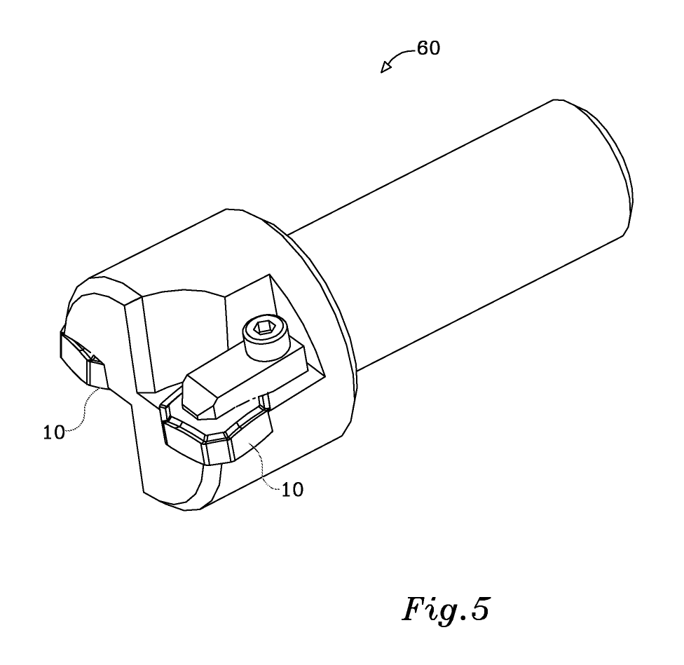

With reference to FIGS. 5 to 10, there is shown a two blade milling tool 60 and several possible clamping techniques that make use of the convex surfaced insert 10.

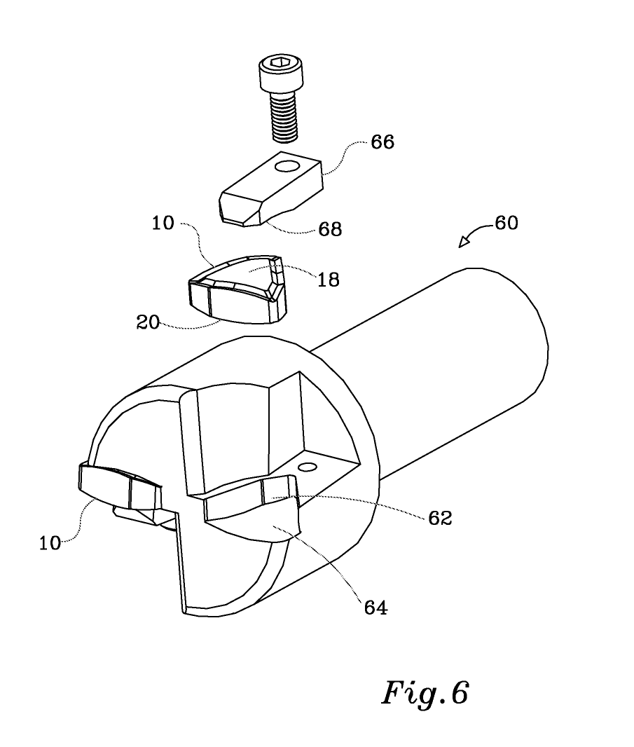

The tool 60 of FIGS. 5 and 6 uses the first and second convex surfaces 18 and 20 of the insert for accurate positioning and tight retaining of the insert 10 in position. As seen in FIG. 6, the bottom face 64 of the pocket 62 and the contact face 68 of the lever clamp 66 are made concave to exactly match the convex first and second surfaces 18 and 20 of the insert 10. However, in the case where the insert in convex only on its upper surface and has a flat lower surface, the bottom face 64 of the pocket 62 is likewise flat. No additional hole or cavity is needed according to this embodiment since the convexity of the insert provides accurate positioning and does not allow slackening of the insert, yielding the maximum strength of the insert 10. It will be understood that the invention also encompasses a single sided convex insert that uses only one of the concave faces 64 and 68.

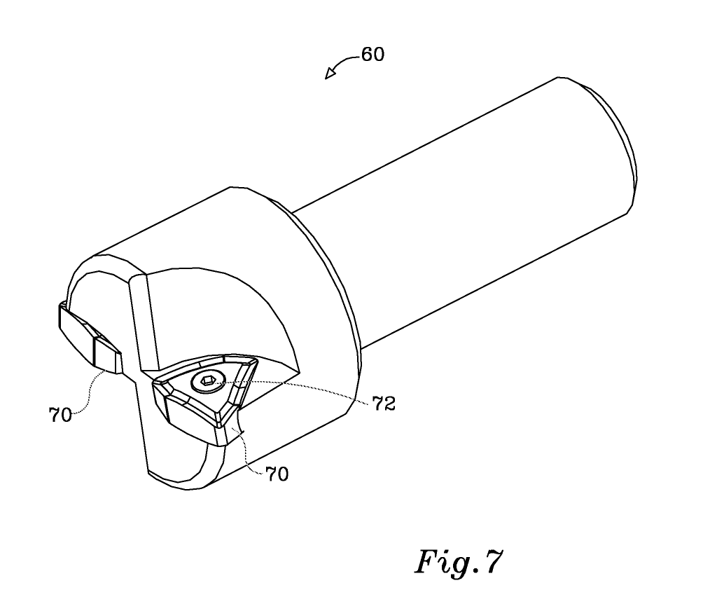

FIG. 7 shows an alternative embodiment where a through-hole convex surfaced triangular insert 70 and a central clamping screw 72 is used to provide through-hole clamping in order to obtain additional free space for chip removal. In cases of severe vibration conditions, dual clamping by a central screw 72 and a lever clamp 66 is also possible.

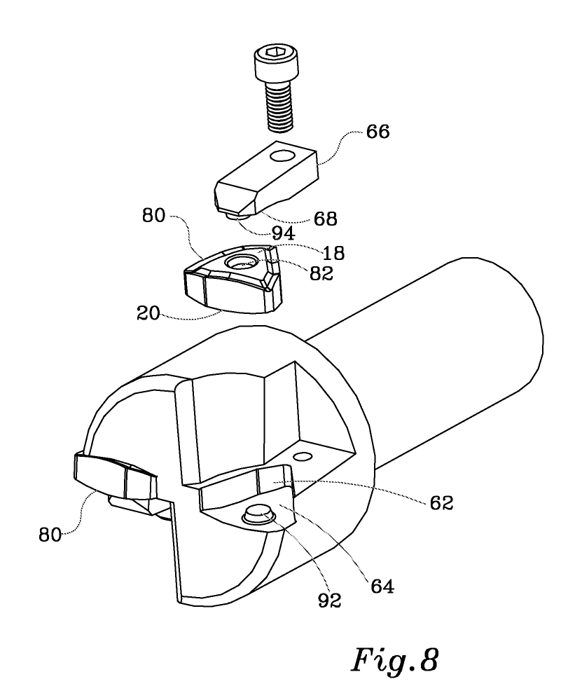

FIG. 8 shows an alternative embodiment of an insert 80 with a round conical cavity 82 located along the rotation symmetry axis 16 on one or both of the first and second convex surfaces 18 and 20. One or both of the bottom face 64 of the pocket 62 and the contact face 68 of the lever clamp 66 has a round conical location pin 92, 94 respectively, protruding from the concave faces 64 and 68, that fits the conical cavities 82 of the insert 80.

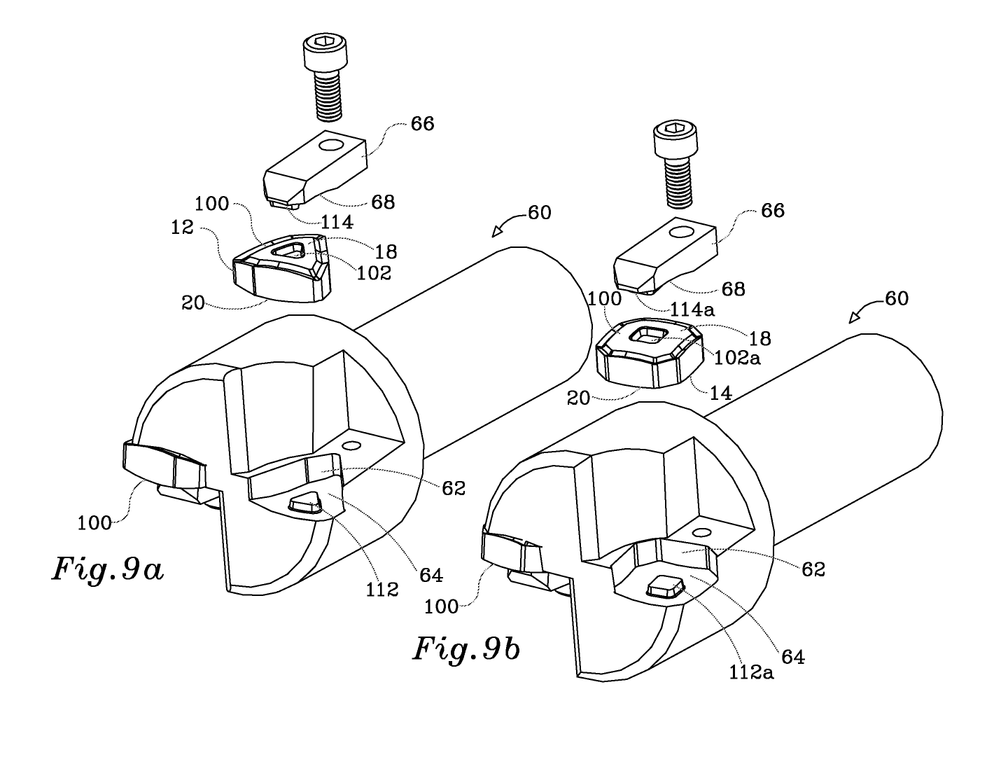

FIGS. 9a and 9b show yet another embodiment of an insert 100 with an indexing cavity 102 or 102a located along the rotation symmetry axis 16 on one or both of the first and second convex surfaces 18 and 20. One or both of the bottom face 64 of the pocket 62 and the contact face 68 of lever clamp 66 has an indexing and location pin 112, 114 or 112a, 114a respectively, protruding from the concave surfaces 64 and 68, that fits one or both indexing cavities 102 or 102a of the insert 100. The triangular insert 12 has a triangular cavity 102 and the square inset 14 has a square cavity 102a. It will be understood however, that any multiple of the number of the polygonal insert faces is also applicable such as hexagonal cavity for a triangular insert and an octagonal cavity for a square insert. Additionally, any other indexing shape such as for example a six point star-shaped pattern that is found in “Torx” keys is also possible.

It will be evident to those skilled in the art that the invention is not limited to the details of the foregoing illustrated embodiments and that the present invention may be embodied in other specific forms without departing from the scope of the claims.

Thus, while the invention has been described with reference to a dual blade cylindrical end mill, the same principles are applicable to any other tipped tool such as rotary cutters with any number of blades evenly or unevenly spaced on the perimeter circle, as well as turning tools, all of which fall within the scope of the claims.

1. A replaceable insert for tipped cutting tools, said replaceable insert comprising a peripheral wall bounding a first surface and an opposite second surface at least one of which surfaces is convex.

2. The insert according to claim 1, wherein a maximum depth of convexity of said convex surface is near the center of maximum stress in the insert material thereby reducing the risk of breakage.

3. The insert as claimed in claim 1, wherein a curved cutting edge is formed circumferentially by the intersection of the entire peripheral wall and at least the first convex surface.

4. The insert as claimed in claim 1, wherein said second surface is also convex and a curved cutting edge is formed circumferentially by the intersection of the entire peripheral wall and each of the first and second convex surfaces.

5. The insert as claimed in claim 1, wherein a circumferential tunnel surrounds at least the first convex surface along the cutting edge, providing a positive cutting angle and chip-breakage properties.

6. The insert as claimed in claim 1, wherein said peripheral wall is defining a polygonal shape.

7. The insert as claimed in claim 6, wherein said polygonal shape has a rotational symmetry and the insert is indexable about an axis of said rotational symmetry.

8. The insert as claimed in claim 6, wherein said polygonal shape comprises main polygon side walls (X), each divided into two sub-faces (Xa, Xb) with an angular shift therebetween.

9. The insert as claimed in claim 8, wherein corner regions formed between any two adjacent side walls or sub-faces are curved in the shape of a circular arc.

10. The insert as claimed in claim 6, wherein said polygonal shape is triangular or square.

11. The insert as claimed in claim 1, wherein the shape of at least the first convex surface is chosen from the list of sphere, cone, pyramid, frustum, and ellipsoid shape.

12. The insert as claimed in claim 1, being adapted for retention in a tipped tool pocket wherein at least one of a bottom face of the pocket and a contact face of lever clamp has a concave surface that exactly matches the convex shape of at least one of said first and second surfaces and of the insert.

13. The insert as claimed in claim 1, wherein a through-hole is made along the rotational symmetry axis of said insert.

14. The insert as claimed in claim 13, being adapted for retention in a tipped tool pocket wherein said bottom face of the pocket has a concave surface that exactly matches the convex shape of at least on of the first and second convex surfaces and a central clamping screw.

15. The insert as claimed in claim 13, wherein a through-hole clamping screw is used simultaneously with a lever clamp.

16. The insert as claimed in claim 1, wherein a round conical cavity is located along the rotation symmetry axis on at least one of the first and second convex surfaces.

17. The insert as claimed in claim 16, wherein at least one of the bottom face of the pocket and the contact face of the lever clamp has a round conical location pin protruding from said at least one concave surface, that fits the at least one conical cavity of the insert.

18. The insert as claimed in claim 1, wherein an indexing cavity is located along the rotation symmetry axis on at least one of the first and second convex surfaces.

19. The insert as claimed in claim 16, wherein at least one of the pocket bottom face and the lever clamp contact face has an indexing and location pin protruding from said at least one concave surface that fits the at least one indexing cavity of the insert.
